(19) United States
(12) Patent Application Publication
(10) Pub. No.: US 2025/0339866 A1
(43) Pub. Date: Nov. 6, 2025

(54) SYSTEM FOR PRECISELY CONTROLLED SPRAYING OF A RELEASE AGENT

(71) Applicant: Accuspray LLC, Urbana, OH (US)

(72) Inventor: William T. Hallmark, Urbana, OH (US)

(21) Appl. No.: 19/194,665

(22) Filed: Apr. 30, 2025

Related U.S. Application Data
(60) Provisional application No. 63/641,573, filed on May 2, 2024.

(51) Int. Cl. B05B 9/04; B05B 12/08; B05B 14/00

(52) U.S. Cl. CPC B05B 9/0403; B05B 12/082; B05B 14/00

(57) ABSTRACT

A system for spraying release agent on a surface, comprising an airless spraying apparatus that includes a pump in fluid communication with a source of release agent configured to draw the release agent into the spraying apparatus; a first solenoid in fluid communication with the pump, wherein the first solenoid includes a spray tip configured to dispense the release agent onto a surface in a controlled manner; a second solenoid in fluid communication with the first solenoid and the pump, wherein the second solenoid and pump are configured to recirculate the release agent through the spraying apparatus in a controlled manner and to remove the release agent from the apparatus; and a controller configured to operate the spraying apparatus, wherein the controller uses firmware or software specific to the spraying apparatus for precisely operating the pump, the first solenoid and spray tip, and the second solenoid.

### CROSS-REFERENCE TO RELATED APPLICATIONS

This patent application claims the benefit of U.S. Provisional Patent Application Ser. No. 63/641,573 filed on May 2, 2024, and entitled “System for Spraying Release Agent”, the disclosure of which is hereby incorporated by reference herein in its entirety and made part of the present U.S. utility patent application for all purposes.

### BACKGROUND

The disclosed technology relates in general to industrial and commercial baking and cooking systems, devices, and methods, and more specifically to an oil spraying system for use with pizza pans, cake pans, and the like.

Existing devices for spraying oil used in cooking or baking applications typically exhibit poor device construction and durability, as well as various other deficiencies including: (i) a tendency to clog; (ii) poor spray consistency; and (iii) excessive time required for spraying pans. Existing devices may not actually spray at all, but rather simply dispense a large, isolated volume of oil into the middle of the pan, which then requires manual spreading of the oil across the surface of the pan. This limitation of existing sprayers results in excessive usage of oil and additional labor. Because these devices do not effectively spray the oil, manual spreading is required, and the resultant absorption of oil into the media used for spreading creates an unacceptable amount of waste. Accordingly, there is an ongoing need for a spraying apparatus that sprays oil and other release agents onto pans quickly and efficiently and that does not suffer from the discussed deficiencies.

### SUMMARY

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One embodiment of the disclosed technology provides a first system for spraying release agent on a surface, comprising a spraying apparatus, wherein the spraying apparatus includes a pump in fluid communication with a source of release agent, wherein the pump is configured to draw the release agent into the spraying apparatus; a first solenoid in fluid communication with the pump, wherein the first solenoid includes a spray tip configured to dispense the release agent onto a surface in a controlled manner; and a second solenoid in fluid communication with the first solenoid and the pump, wherein the second solenoid and pump are configured to recirculate the release agent through the spraying apparatus in a controlled manner and to remove the release agent from the apparatus; and a controller (e.g., computer or microprocessor) configured to operate the spraying apparatus, wherein the controller uses firmware or software specific to the spraying apparatus for precisely operating the pump, the first solenoid and spray tip, and the second solenoid.

In some implementations of the first embodiment, the spraying apparatus is an airless spraying apparatus. In some implementations, the spraying apparatus is configured either as a tabletop apparatus or as a handheld apparatus. In some implementations, the tabletop apparatus further includes a proximity sensor for detecting an object onto which the release agent is to be sprayed. In some implementations, the system is configured for use with release agents of different viscosities. The release agent may be oil or grease used for baking applications. In various implementations, the spray tip of the first solenoid dispenses the release agent in the shape of a cone, and wherein the shape of the cone, diameter of the cone, duration of the cone, and rate of collapse of the cone and resultant residual puddle of the release agent, can be adjusted by the controller. In some implementations, the system is configured to dispense the release agent into a pizza pan, wherein the amount of release agent dispensed into the pan is less than or equal to 3 grams.

Another embodiment of the disclosed technology provides a second system for spraying release agent on a surface, comprising an airless spraying apparatus, wherein the spraying apparatus includes a pump in fluid communication with a source of release agent, wherein the pump is configured to draw the release agent into the spraying apparatus; a first solenoid in fluid communication with the pump, wherein the first solenoid includes a spray tip configured to dispense the release agent onto a surface in a controlled manner; and a second solenoid in fluid communication with the first solenoid and the pump, wherein the second solenoid and pump are configured to recirculate the release agent through the spraying apparatus in a controlled manner and to remove the release agent from the apparatus; a controller (e.g., computer or microprocessor) configured to operate the spraying apparatus, wherein the controller uses firmware or software specific to the spraying apparatus for precisely operating the pump, the first solenoid and spray tip, and the second solenoid; and a cabinet for housing the pump and the second solenoid.

In some implementations of the second embodiment, the spraying apparatus is configured either as a tabletop apparatus or as a handheld apparatus. In some implementations, the tabletop apparatus further includes a proximity sensor for detecting an object onto which the release agent is to be sprayed. In some implementations, the system is configured for use with release agents of different viscosities. The release agent may be oil or grease used for baking applications. In various implementations, the spray tip of the first solenoid dispenses the release agent in the shape of a cone, and wherein the shape of the cone, diameter of the cone, duration of the cone, and rate of collapse of the cone and resultant residual puddle of the release agent, can be adjusted by the controller. In some implementations, the system is configured to dispense the release agent into a pizza pan, wherein the amount of release agent dispensed into the pan is less than or equal to 3 grams.

Still another embodiment of the disclosed technology provides a third system for spraying release agent on a surface, comprising an airless spraying apparatus, wherein the spraying apparatus includes a pump in fluid communication with a source of release agent, wherein the pump is configured to draw the release agent into the spraying apparatus; a first solenoid in fluid communication with the pump, wherein the first solenoid includes a spray tip configured to dispense the release agent onto a surface in a controlled manner; a second solenoid in fluid communication with the first solenoid and the pump, wherein the second solenoid and pump are configured to recirculate the release agent through the spraying apparatus in a controlled manner and to remove the release agent from the apparatus; a controller (e.g., computer or microprocessor) configured to operate the spraying apparatus, wherein the controller uses firmware or software specific to the spraying apparatus for precisely operating the pump, the first solenoid and spray tip, and the second solenoid; and wherein the spray tip of the first solenoid dispenses the release agent in the shape of a cone, and wherein the shape of the cone, diameter of the cone, duration of the cone, and rate of collapse of the cone and resultant residual puddle of the release agent, can be adjusted by the controller.

In some implementations of the third embodiment, the spraying apparatus is configured either as a tabletop apparatus or as a handheld apparatus, wherein the tabletop apparatus further includes a proximity sensor for detecting an object onto which the release agent is to be sprayed. In some implementations, the system is configured for use with release agents of different viscosities. The release agent may be oil or grease used for baking applications. In some implementations, the system is configured to dispense the release agent into a pizza pan, wherein the amount of release agent dispensed into the pan is less than or equal to 3 grams.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and together with the general description given above and detailed description given below, explain the principles of the disclosed subject matter, and wherein:

FIG. 1A is a rear-view schematic diagram of a first example system and apparatus for spraying a release agent such as oil onto the surface of a cooking or baking implement such as a pizza pan showing various components of the system and apparatus, wherein the system and apparatus is configured as a tabletop system;

FIG. 1B is a top-view schematic diagram of the example system and apparatus of FIG. 1A showing additional components of the system and apparatus;

FIG. 2 is a flow chart detailing certain operational aspects of the example system and apparatus of FIGS. 1A-1B;

FIG. 3A is a rear-view schematic diagram of a second example system and apparatus for spraying a release agent such as oil onto the surface of a cooking or baking implement such as a pizza pan showing various components of the system and apparatus, wherein the system and apparatus is configured as a portable or hand-held system;

FIG. 3B is a top-view schematic diagram of the example system and apparatus of FIG. 4A showing additional components of the system and apparatus; and

FIG. 4 is a flow chart detailing certain operational aspects of the example system and apparatus of FIGS. 3A-3B.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

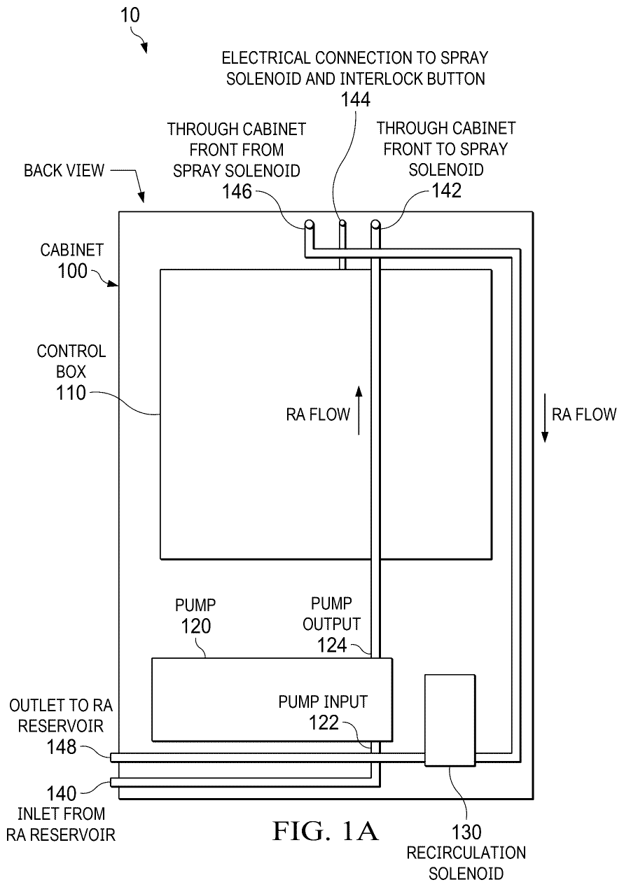

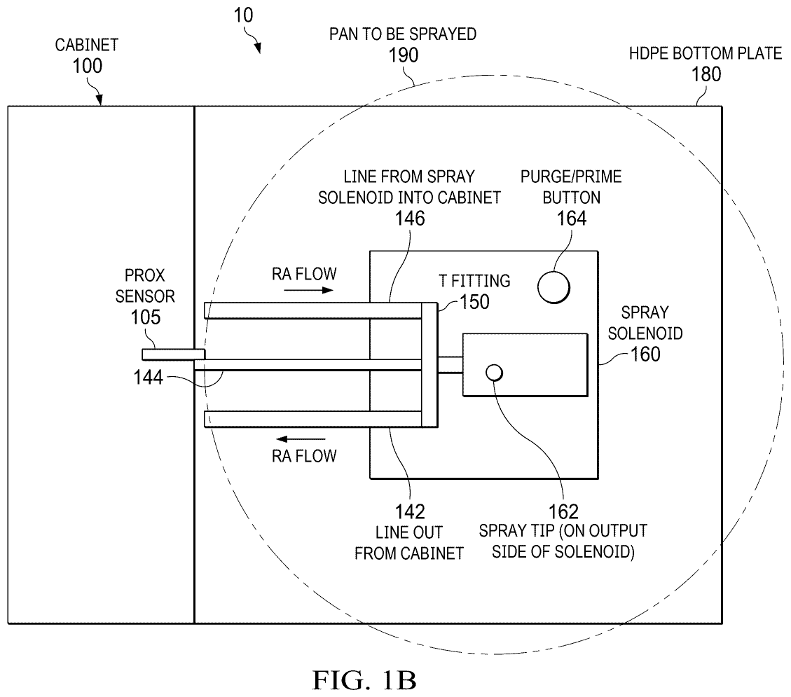

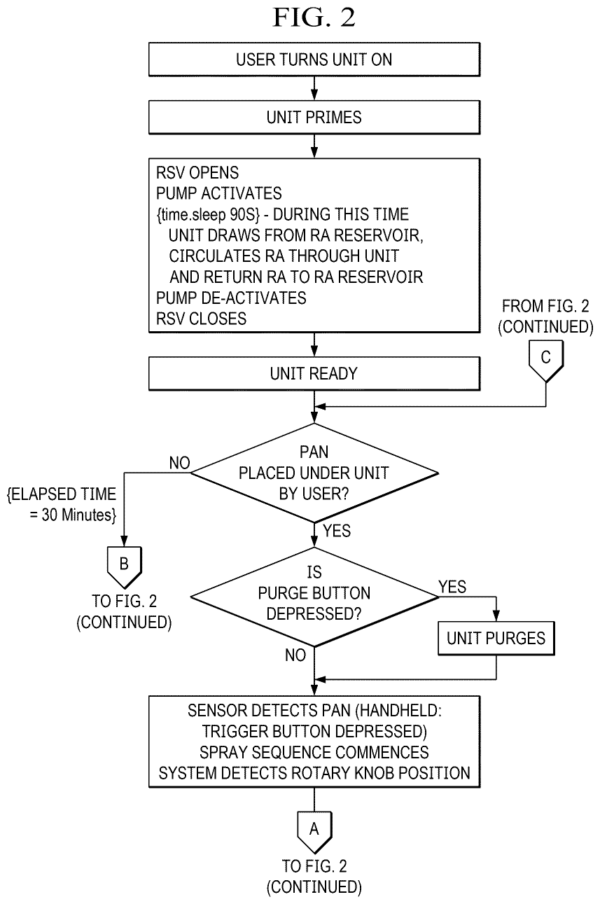

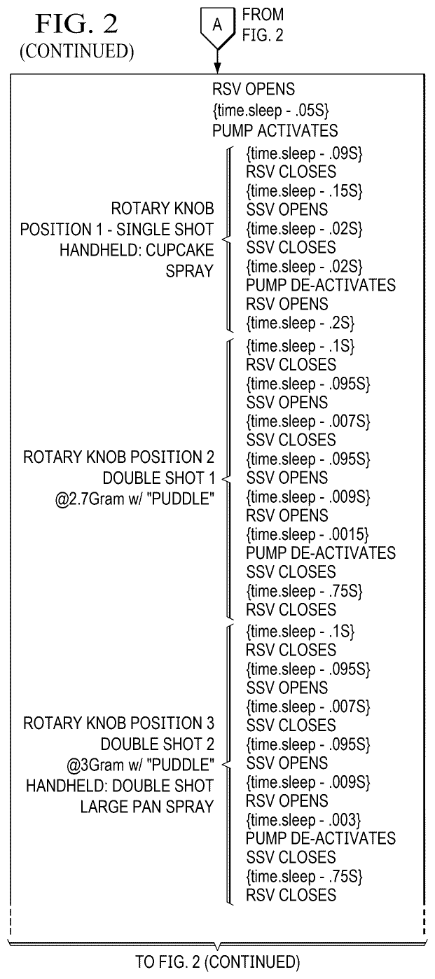

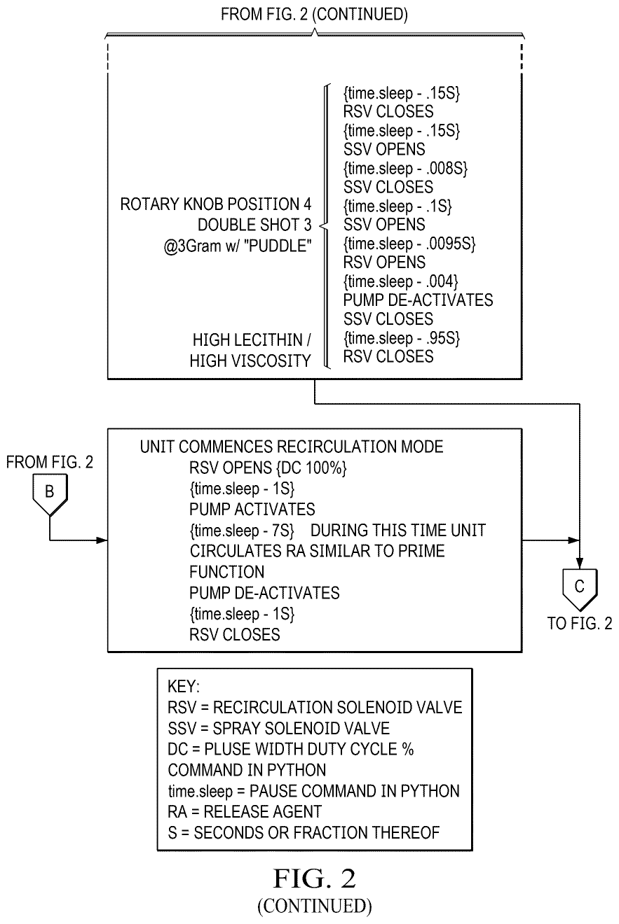

FIG. 1A is a rear-view schematic diagram of a first example system and apparatus for spraying a release agent such as oil onto the surface of a cooking or baking implement such as a pizza pan showing various components of the system and apparatus, wherein the system and apparatus is configured as a tabletop system. FIG. 1B is a top-view schematic diagram of the example system and apparatus of FIG. 1A showing additional components of the system and apparatus. FIG. 2 provides a flow chart detailing the operational aspects of the example system and apparatus of FIGS. 1A-1B. With reference to these Figures generally, an example implementation of the disclosed system includes the following components: (i) a diaphragm pump; (ii) a recirculation solenoid valve; (iii) a spray solenoid valve; (iv) five solid state relays (not shown); (v) a proximity sensor; (not shown); (vi) two power supplies (not shown); and (vii) supply lines and return lines for a release agent, e.g., oil. In an alternate implementation, two solid state relays controlling the recirculation solenoid valve and the spray solenoid valve are replaced with motor drivers which control both the recirculation solenoid and the spray solenoid using pulse-width modulation which emulates variable voltage to control the compression and stroke of the recirculation solenoid valve and the spray solenoid valve. More specifically, as shown in FIGS. 1A-1B, spraying apparatus 10 includes an enclosure or cabinet 100 for housing proximity sensor 105; control box 110; diaphragm pump 120, which includes pump input 122 and pump output 124; recirculation solenoid 130; inlet line from release agent reservoir 140; and outlet line to release agent reservoir 148. Line 142 passes through the front of cabinet 100 to spray solenoid 142. Line 144 provides an electrical connection for powering spray solenoid 142 and an interlock button. Line 146 passes through cabinet 100 from spray solenoid 146 back to recirculation solenoid 130. T-fitting 150 connects lines 142, 144, and 146 to spray solenoid 160, which includes spray tip 162; and purge/prime button 164. Also shown in FIG. 1B is HDPE bottom plate 180 and pan to be sprayed 190 (e.g., pizza pan having a diameter of 14 inches, 12 inches, or 6 inches).

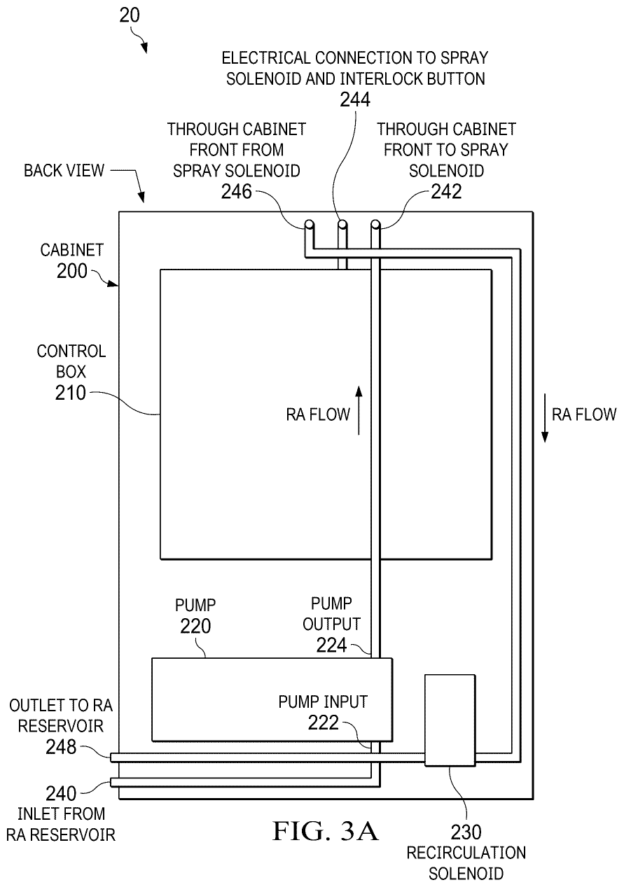

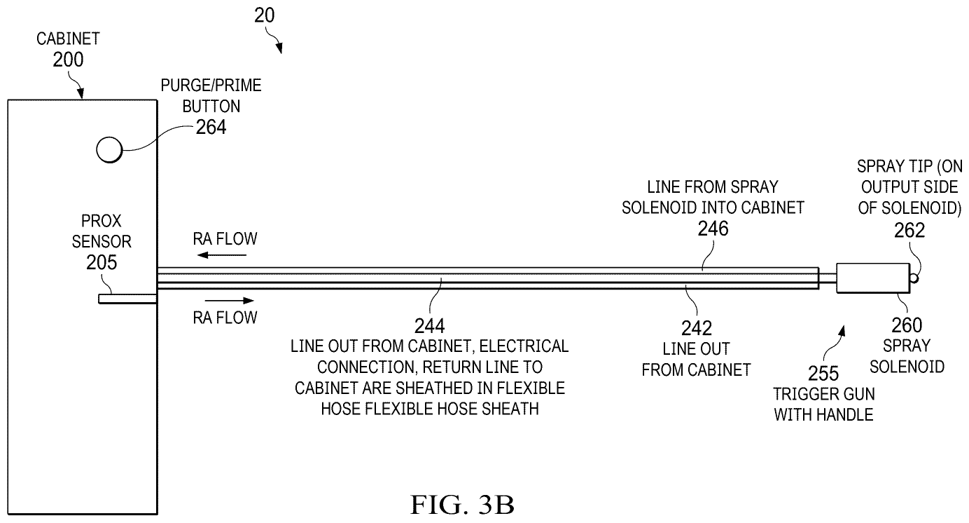

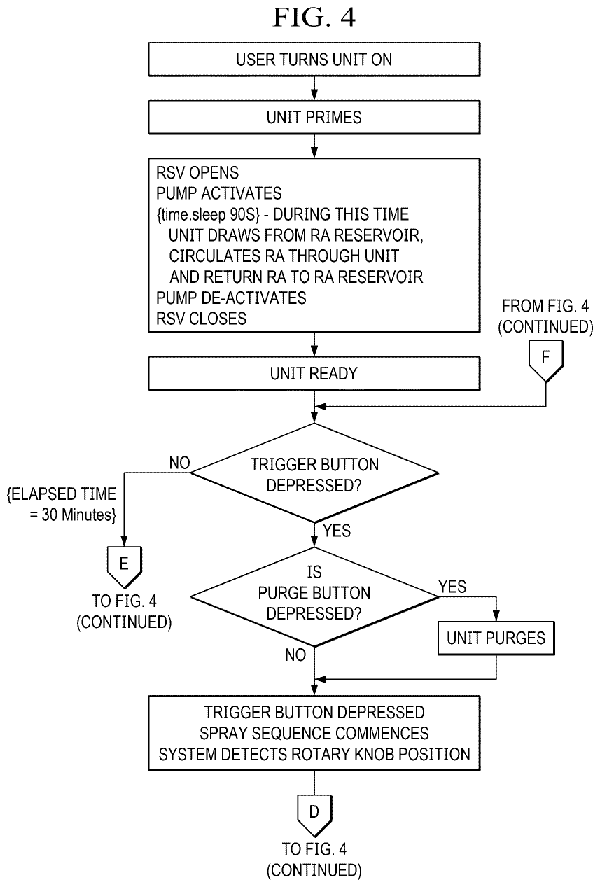

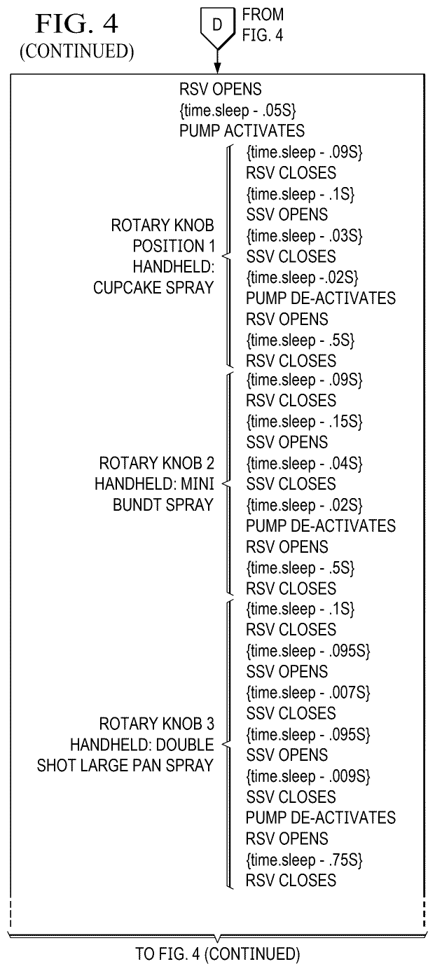

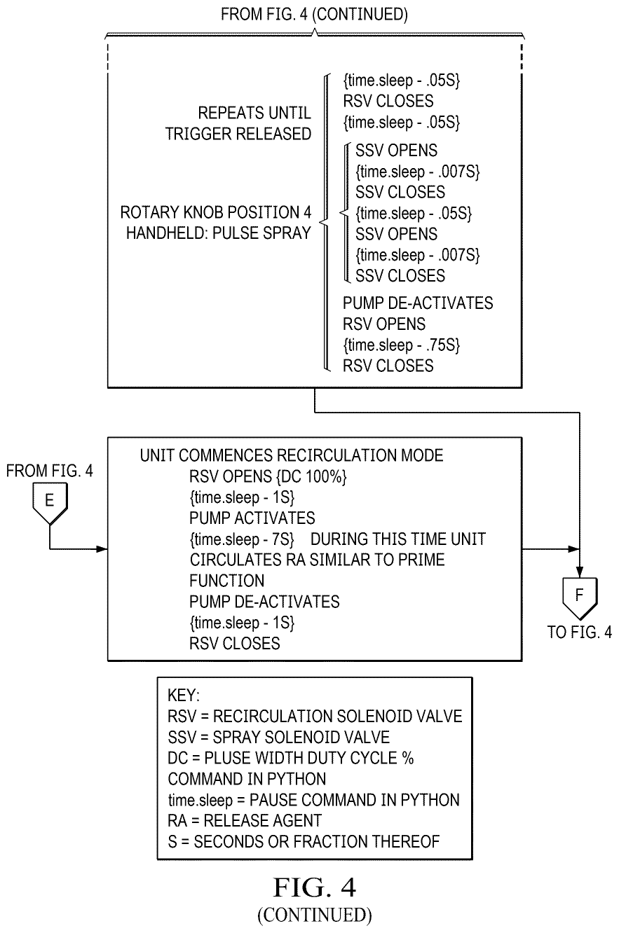

FIG. 3A is a rear-view schematic diagram of a second example system and apparatus for spraying a release agent such as oil onto the surface of a cooking or baking implement such as a pizza pan showing various components of the system and apparatus, wherein the system and apparatus is configured as a portable or hand-held system. FIG. 3B is a top-view schematic diagram of the example system and apparatus of FIG. 3A showing additional components of the system and apparatus. FIG. 4 is a flow chart detailing certain operational aspects of the example system and apparatus of FIGS. 3A-3B. With reference to these Figures generally, an example implementation of the disclosed system includes the following components: (i) a diaphragm pump; (ii) a recirculation solenoid valve; (iii) a spray solenoid valve; (iv) two solid state relays (not shown); (v) a detection sensor; (vi) two motor drivers (not shown); (vii) two power supplies (not shown); and (viii) supply lines and return lines for a release agent, e.g., oil. More specifically, as shown in FIGS. 3A-3B, spraying apparatus 20 includes an enclosure or cabinet 200 for housing proximity sensor 205; control box 210; diaphragm pump 220, which includes pump input 222 and pump output 224; recirculation solenoid 230; inlet line from release agent reservoir 240; and outlet line to release agent reservoir 248. Line 242 passes through the front of cabinet 200 to spray solenoid 242. Line 244 provides an electrical connection for powering spray solenoid 242 and an interlock button. Line 246 passes through cabinet 200 from spray solenoid 246 back to recirculation solenoid 230. Lines 242, 244, and 246 connect to spray solenoid 260, which includes spray tip 262 mounted on trigger gun with handle 255.

Regarding the operation of various embodiments of the disclosed technology, the diaphragm pump (e.g., ShurFlow 100 psi rated) (120,220) draws the release agent from a storage reservoir, circulates the release agent through the system and apparatus (10,20), and generates pressure sufficient to force the release agent through a diffusing spray tip (162,262). The recirculation solenoid valve (e.g., STC 24 vdc, 200 psi rated) (130,230) opens to allow a recirculation of the release agent through the system and a return of the release agent to a storage reservoir during a Prime function and a Periodic Recirculation function. The recirculation solenoid valve (130,230) is also controlled during a Spray function to build pressure adequate for spraying. The spray solenoid valve (160,260) used (e.g., STC 12 vdc, 200 psi rated) allows the release agent to pass through the spray solenoid valve (160,260) and through the diffusing spray tip (162,262). A first solid state relay controls the pump (120,220) motor operation during the Prime, Recirculation, and Spray functions. A second solid state relay controls the recirculation solenoid (130,230) during the Prime, Recirculation, and Spray functions. A third solid state relay controls the spray solenoid (160,260) during the Spray function. A fourth solid state relay is activated by pushing a button or by a sensor and is used to close a circuit on the computer board which initiates the Spray function. A fifth solid state relay controls a chime, light, or other alert device to indicate readiness to spray or other situation or condition. The detection sensor (105,205) is a metal detecting proximity sensor that generates a positive 5 vdc signal upon sensing the immediate proximity of a metal pizza pan (190). In an alternate implementation, an ultrasonic distance sensor is used to generate a positive 5 vdc signal upon sensing a set “distance” from the pan. In another implementation, motor drivers are used rather than solid state relays. These motor drivers emulate a variable voltage by generating a periodic pulse of voltage called a duty cycle. Computer code controls the timing of the periodic signal and the “rest” cycle, the control of which is known as pulse-width modulation (“PWM”). Controlling the PWM can emulate a higher or lower voltage, thereby causing the spray solenoid (160,260) valve to open more quickly and more fully, thereby altering spray strength and duration. A second motor driver controls the recirculation solenoid valve (130,230), thereby altering backpressure (e.g., increasing or decreasing) which in turn alters spray strength (e.g., increased backpressure results in stronger spray strength and decreased backpressure results in weaker spray strength. A first power supply (110/120 to 24 vdc or 110/120 to 12 vdc) powers the pump (120,220) and solenoid valves (130,230,160,260). A second power supply (110/120 to 5 vdc) powers the processor, relay valves, and motor drivers. The disclosed system draws release agent from a bucket or other container used as a storage medium. During recirculation and priming, the return line (148,248) returns the release agent to the storage container. More specifically, a ¼ ID high-pressure braided vinyl line transfers the release agent under pressure downstream from the pump (120,220) to a T-fitting (150) positioned directly behind the spray solenoid valve (160,260). A ¼ ID high-pressure braided vinyl line transfers the release agent from the T fitting (150) to the recirculation solenoid valve (130,230). A ⅜ vinyl braided line is used to supply release agent from the reservoir to the pump (120,220) and a ⅜ vinyl braided line is used to return the release agent downstream from the recirculation solenoid (130,230) back to the reservoir.

An example implementation of the disclosed system, rather than using mechanical or electronic timers, the spray function is controlled by a small onboard microprocessor/single board computer using firmware specific to the system or computer code script developed specifically for the system using, for example, Python or another code language. The computer code may be written as execute-on-boot Python file that opens and runs the program anytime the system is powered-on.

At system power-on, the Prime function opens the recirculation solenoid (130,230) valve and powers the pump (120,220) to enable the system to prime with fresh release agent (e.g., oil or grease). This occurs at start up or anytime the code restarts in its sequence such as a power outage. The release agent is drawn from the reservoir to the pump (120,220), which in turn circulates the release agent through the T fitting (150) adjacent to the spray solenoid (160,260) valve, back down and through the recirculation solenoid (130,230) valve, and back to the release agent reservoir. The duration of the Prime function can be controlled by altering the computer code that operates the system. Once the system has primed it indicates readiness to spray a pan using an audible two-beep signal.

An example implementation of the disclosed spraying system includes a periodic recirculation function. A Python threading function and daemon background script enable the system to perform an independent periodic recirculation function at a user defined interval. For example, if set to 1200, the system will recirculate by drawing release agent from the reservoir approximately every 30 minutes. This supply is recirculated through the system lines and returned as discharge to the release agent reservoir. This feature has utility for cake grease or higher viscosity release agent or any instance where the release agent needs to be heated. This function is automatic and does not require user intervention.

In an example implementation of the disclosed spraying system, the Spray function is initiated using signal from a sensor that is either the metal proximity sensor (105,205) or an ultrasonic distance sensor. The signal is a +5 vdc signal that is received by a solid state relay. The signal causes the normally open relay to close, which in turn closes the circuit between a ground pin and a designated GPIO pin on the computer board. This is read by the code as an “event” which prompts the code to initiate a Spray function cycle. In one implementation, the Spray function cycle is fixed. In an alternate implementation, the Spray function cycle varies according to the temperature of the release agent in the reservoir, which is sensed by a temperature probe. Upon detecting the “event” for the an initial Spray cycle function in the program after the system has been at rest, the controller/processor: (i) opens the recirculation solenoid valve (130,230) (in one implementation, a motor driver opens the valve using a full 100% duty cycle, i.e., complete compression of duty and rest cycles); (ii) momentarily later, starts the pump (120,220) operation which is maintained for a set time period; (iii) momentarily later, closes the recirculation solenoid (130,230) valve completely or changes the duty cycle to 40% emulating a lower voltage and in turn partially closing the valve which allows the pump (120,230) to build head pressure; (iv) momentarily later, pulses the spray solenoid (160,260) valve with a full 24 vdc, which enables it snap open and close quickly twice to spray the pan (190) twice (in an alternate implementation, a duty cycle of less than 100% can be used to lessen the degree of valve travel and responsiveness and in turn alter the spray strength); and (v) momentarily later, and after the spray solenoid (160,260) valve has “pulsed”, opens the recirculation valve to enable the pump (120,220) to continue operation without the deadheading the pump. In an alternate implementation, the recirculation solenoid (130,230) valve opens momentarily before the spray solenoid (160,260) valve closes to achieve a rapid spray cone collapse and resultant “puddle” of release agent in the center of the pan. For subsequent spray cycle functions beyond the initial spray cycle function, the pump (120,130) is already in operation, and upon detecting an “event” for the spray cycle, the recirculation valve and spray valve operate in a manner similar to (iii) and (iv) above. The pump (120,220) is controlled by a Python threaded daemon script (Pump Background) that runs in the background but parallel to the main script that controls the spray cycle. Upon sensing an “event” through the proximity sensor (105,205) the Pump Background script runs the pump for approximately 30 seconds beyond the last instance in which a pan (190) is sensed by the proximity sensor (105,205). These process steps allow the system to achieve an effective conical spray of the pan with a variation from spray to spray of less than 0.01 gram. The operation described above typically occurs in less than one second.

In an alternate implementation, a range function is used within the Spray function, which alters the duration of valve opening depending on the temperature of the release agent. For example, a colder sensed temperature would be indicative of a thicker release agent viscosity. In this instance, the delay of time between the recirculation solenoid valve closing and the pulse of the spray solenoid valve would be lengthened, and the duration of the pulse would be lengthened, which would enable a consistent spray at lower temperatures and thicker viscosity. This arrangement would be useful in a store or production facility where the morning temperature is low, but wherein the facility heats up during the day.

In an alternate implementation, a selector switch is used which closes a circuit between various selected GPIO pins and ground on the computer board. The system reads this selection as an “if/then” condition in the computer code which runs a designated block of code within the main code script which discreetly controls the spray pattern enabling the user to select a particular spray pattern for a particular pan.

In an alternate implementation, a small camera is used to take an image of the pan upon sensing of a pan by the proximity sensor. The image of the pan is then processed by the computer code which in turn selects a spray pattern based on the condition of the pan or whether (e.g.) the pan has dough in it.

One implementation of the system described herein is configured as a “tabletop” single pan sprayer with a fixed overhead spray tip. In another embodiment, the spraying apparatus affixes to a wall and a sliding articulating spray head is used in conjunction with an ultrasonic depth sensor to spray multiple stacks of pans. In this implementation, a laser dot is used to center the spray head on the pan and pull down on the spray head. Once the spray head reaches an optimum preset distance from the pan the Spray function automatically initiates. In another implementation, a handheld spray gun is attached to the apparatus using a flexible conduit which contains the supply lines, return lines, and the electrical connection for the spray solenoid valve. The Prime and Recirculation functions work the same—the Spray function can be a single pulse to spray a single cavity or a continuous sequence of pulses to spray a large pan containing many cavities. One implementation includes electronic ball valves that open or close to enable a “purge” medium to circulate through the system to clean it at the end of a shift. In still another implementation, computer code tracks the sequence of Spray functions initiated and tabulates this information which is used to transmit data on usage as needed for store performance tracking or release agent inventory use and control.

The disclosed system and apparatus can be readily adapted to other bakery environments. Replacing the articulating arm with a hose and remote handheld spray gun enables the system to be used in a smaller bakery. The system pumps and sprays cake grease, as well as bread pan release oil. Either a conical tip or fan tip can be used. Finally, the system can be operated using a 12V or 24V Lithium Polymer battery that enables the system to be located on a remote cart for flexibility. The system as described herein requires a minimal degree of fabrication and can be completely assembled in about five hours. The computer code needed for the processor is stored on an SD card which also contains the computer operating system. This card can be readily “flashed” in approximately five minutes.

All literature and similar material cited in this application, including, but not limited to patents, patent applications, articles, books, treatises, and web pages, regardless of the format of such literature and similar materials, are expressly incorporated by reference in their entirety. Should one or more of the incorporated references and similar materials differ from or contradict this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For one of ordinary skill in the art, the specific meaning of the above terms in the disclosed technology may be understood according to specific circumstances.

The disclosed technology can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, the disclosed technology can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, disclosed methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes but is not limited to portable or fixed storage devices, optical storage devices, wireless channels, and/or various other storage mediums capable of storing that contain or carry instruction(s) and/or data.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

What is claimed:

1. A system for spraying release agent on a surface, comprising:
(a) a spraying apparatus, wherein the spraying apparatus includes:
(i) a pump in fluid communication with a source of release agent, wherein the pump is configured to draw the release agent into the spraying apparatus;
(ii) a first solenoid in fluid communication with the pump, wherein the first solenoid includes a spray tip configured to dispense the release agent onto a surface in a controlled manner; and
(iii) a second solenoid in fluid communication with the first solenoid and the pump, wherein the second solenoid and pump are configured to recirculate the release agent through the spraying apparatus in a controlled manner and to remove the release agent from the apparatus;
(b) a controller configured to operate the spraying apparatus, wherein the controller uses firmware or software specific to the spraying apparatus for precisely operating the pump, the first solenoid and spray tip, and the second solenoid.

2. The system of claim 1, wherein the spraying apparatus is an airless spraying apparatus.

3. The system of claim 1, wherein spraying apparatus is configured either as a tabletop apparatus or as a handheld apparatus.

4. The system of claim 3, wherein the tabletop apparatus further includes a proximity sensor for detecting an object onto which the release agent is to be sprayed.

5. The system of claim 1, wherein the system is configured for use with release agents of different viscosities.

6. The system of claim 1, wherein the release agent is oil or grease used for baking applications.

7. The system of claim 1, wherein the spray tip of the first solenoid dispenses the release agent in the shape of a cone, and wherein the shape of the cone, diameter of the cone, duration of the cone, and rate of collapse of the cone and resultant residual puddle of the release agent, can be adjusted by the controller.

8. The system of claim 1, wherein the system is configured to dispense the release agent into a pizza pan, and wherein the amount of release agent dispensed into the pan is less than or equal to 3 grams.

9. A system for spraying release agent on a surface, comprising:
(a) an airless spraying apparatus, wherein the spraying apparatus includes:
(i) a pump in fluid communication with a source of release agent, wherein the pump is configured to draw the release agent into the spraying apparatus;
(ii) a first solenoid in fluid communication with the pump, wherein the first solenoid includes a spray tip configured to dispense the release agent onto a surface in a controlled manner; and
(iii) a second solenoid in fluid communication with the first solenoid and the pump, wherein the second solenoid and pump are configured to recirculate the release agent through the spraying apparatus in a controlled manner and to remove the release agent from the apparatus;
(b) a controller configured to operate the spraying apparatus, wherein the controller uses firmware or software specific to the spraying apparatus for precisely operating the pump, the first solenoid and spray tip, and the second solenoid; and
(c) a cabinet for housing the pump and the second solenoid.

10. The system of claim 9, wherein spraying apparatus is configured either as a tabletop apparatus or as a handheld apparatus.

11. The system of claim 10, wherein the tabletop apparatus further includes a proximity sensor for detecting an object onto which the release agent is to be sprayed.

12. The system of claim 9, wherein the system is configured for use with release agents of different viscosities.

13. The system of claim 9, wherein the release agent is oil or grease used for baking applications.

14. The system of claim 9, wherein the spray tip of the first solenoid dispenses the release agent in the shape of a cone, and wherein the shape of the cone, diameter of the cone, duration of the cone, and rate of collapse of the cone and resultant residual puddle of the release agent, can be adjusted by the controller.

15. The system of claim 9, wherein the system is configured to dispense the release agent into a pizza pan, and wherein the amount of release agent dispensed into the pan is less than or equal to 3 grams.

16. A system for spraying release agent on a surface, comprising:
(a) an airless spraying apparatus, wherein the spraying apparatus includes:
(i) a pump in fluid communication with a source of release agent, wherein the pump is configured to draw the release agent into the spraying apparatus;
(ii) a first solenoid in fluid communication with the pump, wherein the first solenoid includes a spray tip configured to dispense the release agent onto a surface in a controlled manner; and
(iii) a second solenoid in fluid communication with the first solenoid and the pump, wherein the second solenoid and pump are configured to recirculate the release agent through the spraying apparatus in a controlled manner and to remove the release agent from the apparatus;
(b) a controller configured to operate the spraying apparatus, wherein the controller uses firmware or software specific to the spraying apparatus for precisely operating the pump, the first solenoid and spray tip, and the second solenoid; and
(c) wherein the spray tip of the first solenoid dispenses the release agent in the shape of a cone, and wherein the shape of the cone, diameter of the cone, duration of the cone, and rate of collapse of the cone and resultant residual puddle of the release agent, can be adjusted by the controller.

17. The system of claim 16, wherein spraying apparatus is configured either as a tabletop apparatus or as a handheld apparatus, and wherein the tabletop apparatus further includes a proximity sensor for detecting an object onto which the release agent is to be sprayed.

18. The system of claim 16, wherein the system is configured for use with release agents of different viscosities.

19. The system of claim 16, wherein the release agent is oil or grease used for baking applications.

20. The system of claim 16, wherein the system is configured to dispense the release agent into a pizza pan, and wherein the amount of release agent dispensed into the pan is less than or equal to 3 grams.
